(19) United States
(12) Patent Application Publication
(10) Pub. No.: US 2010/0049775 A1
(43) Pub. Date: Feb. 25, 2010

(54) Method and System for Allocating Memory in a Computing Environment

(75) Inventor: Mayank Rajawat, Bangalore (IN)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/596,966

(22) PCT Filed: Apr. 24, 2008
(86) PCT No.: PCT/IN08/00260

§ 371 Date: Oct. 21, 2009

(30) Foreign Application Priority Data
Apr. 26, 2007 (IN) 894/CHE/2007

(51) Int. Cl. G06F 12/02; G06F 12/00; G06F 17/30

(52) U.S. Cl. 707/813; 711/170; 707/E17.01; 711/E12.001; 711/E12.002

(57) ABSTRACT

A method and product for allocating memory in a computing environment, the method comprising providing a memory allocation routine adapted to use mmap( ) with a MAP SHARED or equivalent flag specified so that the memory is allocated from a file system buffer cache. In one embodiment, the method comprises allocating the memory by using mmap( ) with a MAP_SHARED or equivalent flag specified so that the memory is allocated from a file system buffer cache.

### BACKGROUND OF THE INVENTION

Applications running on Unix and Unix-like operating systems use malloc( ) and its associated family of routines (each member of which is referred to as a malloc( ) family routine) to allocate, obtain and reserve memory for data structures (and subsequently free such memory). The total amount of memory that can be allocated with malloc( ) depends on the total swap space with which the system is configured. The available memory is further shared with other users of so-called ‘anonymous memory’, such as ‘shared memory’. ‘Anonymous memory’ is memory that does not have a named file system object as a backup permanent store.

The malloc( ) family of routines depends on two methods (“system calls”) to obtain memory from the operating system: i) brk( ), and ii) mmap( ) with MAP_PRIVATE flag. These two methods allow applications and processes to use the anonymous memory via the malloc( ) interface. The anonymous memory ‘chunk’ is used by the application or process to lay out the data structures on it.

In current operating system design the memory pages of anonymous memory can be swapped out to the swap device (viz. disk) only. Hence, the maximum amount of anonymous memory that is available to existing applications is limited by the total amount of swap space configured in the relevant system. If a system is low on virtual memory (i.e. little or no swap space is available), malloc( ) failures will be reported to applications, which for most applications is fatal.

One existing approach to overcoming this problem involves halting or calling mmap( ) directly. If the system runs out of swap space (also reported as a “low virtual memory condition”), the user level malloc( ) requests report a failure. The application is required to handle the failure any way it chooses. Typically most applications respond with exit or halt. Some applications call mmap( ) directly with MAP_SHARED to get the memory.

However, halt is not a particular useful solution as it interrupts further processing, even if it does avoid a system crash. The direct use of mmap( ) requires that checks be inserted in the application code to track what memory is allocated with mmap( ) and what is allocated using malloc( ); the user is required to maintain the temporary files, and existing applications must undergo code change or be risk persist halts.

Another approach, though whose primary aim is to allow applications to use shared datastructures, is embodied in mmalloc( ) of the Linux (trade mark) operating system. The mmalloc( ) routine allows a user to supply a filename to be mapped with mmap( ). However, extensive source code changes are still required, so this approach is generally useful only for new applications, not existing applications. In addition, this approach is essentially the equivalent of an application's directly calling mmap instead of malloc( ), as the user must still supply the filename; mmalloc( ) is merely performing memory management. Furthermore, in this approach the user must choose between mmalloc( ) and malloc( ).

### BRIEF DESCRIPTION OF THE DRAWING

In order that the invention may be more clearly ascertained, embodiments will now be described, by way of example, with reference to the accompanying drawing, in which:

FIG. 1 is a schematic view of a system according to an embodiment of the present invention.

FIG. 2 is a flow diagram of a method according to an embodiment of the present invention employed by the system of FIG. 1.

FIG. 3 is a flow diagram of another method according to an embodiment of the present invention employed by the system of FIG. 1.

### DETAILED DESCRIPTION OF THE EMBODIMENTS

There will be provided a method, a software product and a computing system for allocating memory in a computing environment.

In one embodiment, the method comprises providing a memory allocation routine adapted to use mmap( ) with a MAP_SHARED or equivalent flag specified so that the memory is allocated from a file system buffer cache. In another embodiment, the method comprises allocating the memory by using mmap( ) with a MAP_SHARED or equivalent flag specified so that the memory is allocated from a file system buffer cache.

In one embodiment, the software product is for adjusting parameters for dynamic memory allocation, and comprises a configuration command usable to control a memory allocation routine invocation to use mmap( ) with MAP_SHARED.

There will also be provided a computing system. In one embodiment, the system comprises a memory allocation routine adapted to use mmap( ) with a MAP_SHARED or equivalent flag specified so that the memory is allocated from a file system buffer cache.

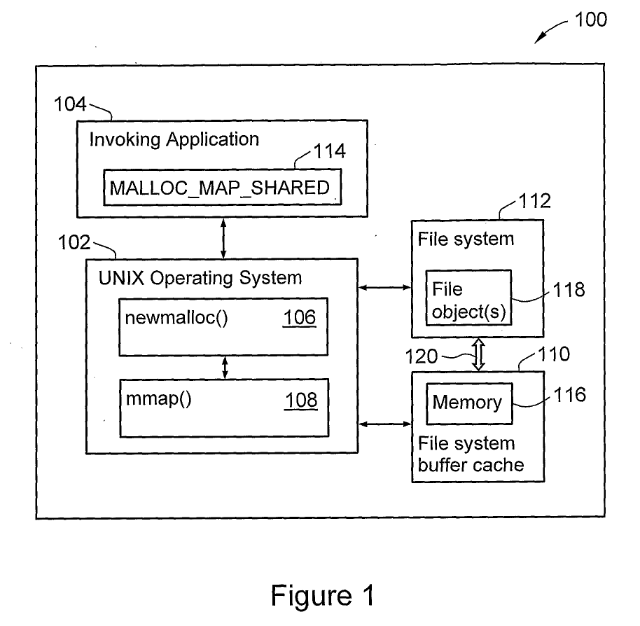

FIG. 1 is a highly schematic view of a computing system 100 according to an embodiment of the present invention. Only features relevant to gaining an understanding of this embodiment are shown. Thus, system 100 includes a UNIX (trade mark) operating system 102 and an application 104, termed the “invoking application”. The operating system 102 includes an implementation of a family of memory allocation routines (comparable to the malloc( ) family of routines in conventional systems), including in particular a memory allocation routine termed, in this embodiment, newmalloc( ) 106. The term newmalloc( ) is used to distinguish this memory allocation routine from the conventional malloc( ) memory allocation routine; in use, however, it will still be invoked in the user application with the name “malloc( )”, so that the code of the application need not be changed in that regard. However, as explained, the implementation of the memory allocation routine in the operating system (identified herein as newmalloc( ) 106) differs from the implementation of the conventional malloc( ).

The routine newmalloc( ) 106 is comparable to malloc( ) and can be controlled to behave as does malloc( ) if desired, but also contains additional functionality (as will be described below). In addition, operating system 102 includes an implementation of an mmap( ) function 108, which is essentially identical with the conventional mmap( ) function. The system 100 also includes a file system buffer cache 110 and a file system 112.

In this example, invoking application 104 is configured to invoke newmalloc( ) 106 when it requires the allocation of memory. In addition, invoking application 104 can employ an environmental variable MALLOC_MAP_SHARED 114, with values 0 and 1. This variable can be inspected by newmalloc( ) 106 and thereby used to control newmalloc( ).

The routine newmalloc( ) 106 is configured such that, if called to allocate memory and environmental variable MALLOC_MAP_SHARED 114 is set to 0, it is configured to allocate memory in the same manner as does conventional malloc( ) (i.e. using sbrk( ) or malloc( ) with MAP_PRIVATE set). However, if newmalloc( ) is called to allocate memory and environmental variable MALLOC_MAP_SHARED 114 is set to 1, newmalloc( ) is configured to allocate memory to use mmap( ) function 108 with the flag MAP_SHARED specified. Though not depicted in this figure, operating system 102 also includes implementations of the other members of the malloc( ) family of routines (e.g. realloc( ), calloc( )), configured to operate according to the same principle.

The mmap( ) function 108, when MAP_SHARED is specified, returns memory 116 from the file system buffer cache 110, which is backed to a file object 118 (of which there will generally be a plurality) in the file system 112, rather than anonymous memory in swap space. This means that no space need be reserved on a swap device to swap the allocated memory out; thus, the memory 116 returned by mmap( ) (with the MAP_SHARED flag specified) will be swapped out (indicated by arrow 120)—as necessary—to the file object 118 in the file system 112. Little if any change is required to existing code, and any calls to realloc( ) can be readily effected by extending the current filesize with lseek( ) and write( ) system calls to appropriately offset and extend the region mapped with mmap; hence, copying of data can also generally be avoided.

Hence, if MALLOC_MAP_SHARED is set to 1 in the invoking environment, the family of memory allocation routines according to this embodiment (including newmalloc( ) 106) use mmap( ) with MAP_SHARED specified to allocate memory. This allows existing binaries to use malloc( ) without changing the source code (which obviates the problem, in particular, of making such changes when that code is unavailable).

The family of memory allocation routines according to this embodiment can also be triggered to use mmap( ) with MAP_SHARED specified by developers using the mallopt( ) call, by using a group of five commands (discussed below).

The family of memory allocation routines according to this embodiment (including most particularly newmalloc( ) 106) takes advantage of the knowledge of the block-size of the file system to do efficient I/O. Further, in “safe mode”, the family of memory allocation routines according to this embodiment creates a file of length greater than requested size by two pages, maps with mmap(MAP_SHARED) the entire length of the new file, marks the first and last pages of the file unwritable using fcntl( ) (e.g. by creating a “hole”) or unmapping them, returns the address to the application at the end of the first page, and allows any overflow and underflow of pointers to be readily caught as pagefaults.

Interfaces Exposed to the Developers

As discussed above, developers using the mallopt( ) call can also trigger the family of memory allocation routines according to this embodiment to use mmap( ) with MAP_SHARED specified. A set of five configuration commands are, according to this embodiment, added to mallopt( ) to allow the application to signal to the family of memory allocation routines to use mmap( ) with MAP_SHARED specified when desired so that, whenever an application invokes one of the family of memory allocation routines, it will be returned with memory allocated using mmap( ) with MAP_SHARED specified.

The five configuration commands added to mallopt( ) are:

i) M_MAP_SHARED_ON: enables invocations of the family of memory allocation routines to use mmap with MAP_SHARED specified whenever needed;

ii) M_MAP_SHARED_PREFERRED: enables invocations of the family of memory allocation routines to give preference to MAP_SHARED on MAP_PRIVATE or brk( );

iii) M_MAP_SHARED_ONCE: only the next call to the family of memory allocation routines will use MAP_SHARED—which can be used by applications that it is desired not get fork-unsafe memory unless confident;

iv) M_MAP_SHARED_OFF: switches off the use of MAP_SHARED, so the family of memory allocation routines of this embodiment will behave like the conventional malloc( ) family; and

v) M_MAP_SHARED_FLOW_CHECK: allocates memory in “safe mode” to allow the memory to have an overflow/underflow check as described above.

These mallopt( ) configuration commands supplement the environmental variable MALLOC_MAP_SHARED which, as discussed above, is provided principally so that the end user can allow his or her existing executables to use the family of memory allocation routines of this embodiment.

Temporary File Objects

To use mmap( ) with the MAP_SHARED flag specified, newmalloc( ) 106 creates the file object 118 with a random name (generated as required), in a temporary directory. This temporary directory might be named, for example, “/var/tmp/malloc/1209/” (where “1209” is the pid of the invoking application). To delete these temporary files, a deletion routine for each new file is registered at the exit time.

When memory allocated using newmalloc( ) is released using free( ), free( ) deletes the temporary directories and files. If the user application exits without calling free( ), the files are cleaned up (viz. deleted) in exit( ); to facilitate this, when newmalloc( ) is used for the first by the application newmalloc( ) registers a cleanup routine using atexit( ), and the routine in atexit( ) is passed a list of files that should be deleted at exit. If the application is terminated abruptly, so that it fails to cleanup at exit in this manner, the temporary files are cleaned up during the next boot.

Alternatively, the temporary files can be periodically cleaned, such as whenever there is no reference count on them. This eliminates any restriction on the total memory that newmalloc( ) can return to applications, based on the amount of swap configured.

Use

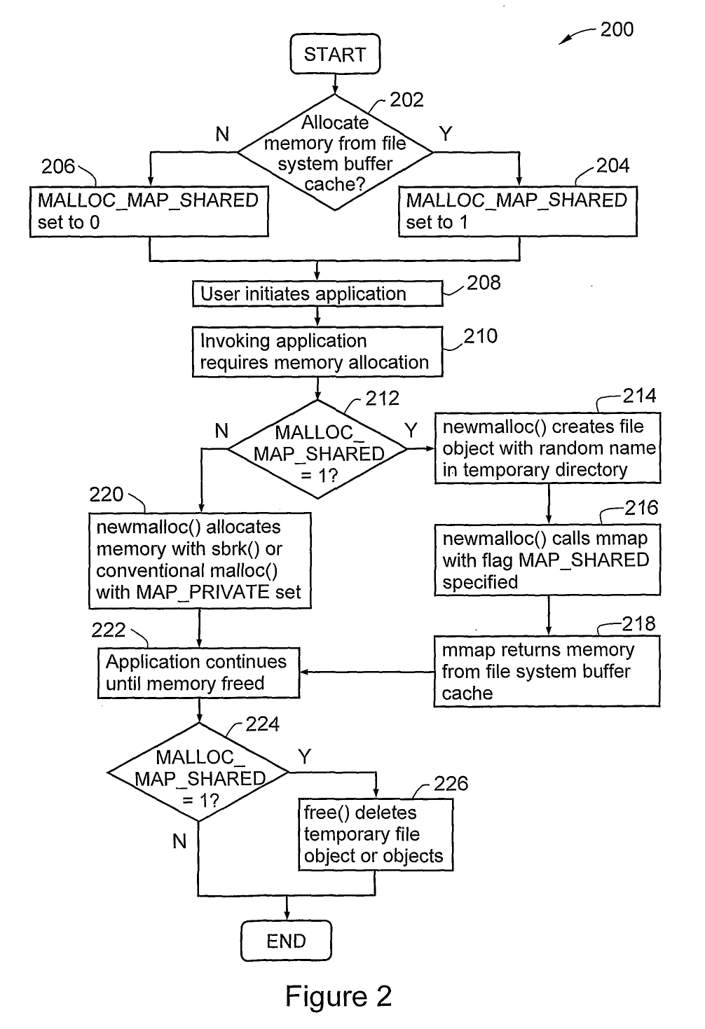

FIG. 2 is a flow diagram of the operation of the system 100 of FIG. 1. If a user has experienced or expects to experience memory allocation failures with a third party application (perhaps with source code either unavailable or too complex to change), at step 202 the user decides whether memory is to be allocated by conventional methods (perhaps because the application includes extensive forking) or from the file system buffer cache. If by conventional methods, processing passes to step 204 where the MALLOC_MAP_SHARED environmental variable is set to 0, then continues at step 208. If memory is to be allocated from the file system buffer cache, processing passes to step 206, where the MALLOC_MAP_SHARED environmental variable is set to 1 after which processing then continues at step 208.

Setting the MALLOC_MAP_SHARED environmental variable to 1 means that, in due course, the memory allocation family of routines of this embodiment (including newmalloc( )) will use mmap with MAP_SHARED specified, without changing the executable of the application, and hence allocate memory from the file system buffer cache. As a result, the allocated memory is backed to a file object 118 in the file system 112, rather than to anonymous memory. The user should ensure that the executable is not using fork( ) (such as by running “nm” on the application binary and looking for fork( ), or consulting the provider of the application as necessary). (If the executable is using fork( ), the MALLOC_MAP_SHARED environmental variable should be set to 0 at step 206.)

At step 208, the user initiates the application 104 that will in due course invoke newmalloc( ). At step 210, the invoking application requires memory allocation so invokes newmalloc( ). At step 212, the operating system 102 ascertains whether MALLOC_MAP_SHARED is set to 1. If so, processing continues at step 214, where newmalloc( ) creates a new file object with a random name in a temporary directory; also, if this is the first use of newmalloc( ) by the application with MALLOC MAP_SHARED set to 1, as discussed above newmalloc( ) registers a cleanup routine using atexit( ), to be passed a list of files that should be deleted at exit. This list is maintained in subsequent uses of newmalloc( ).

At step 216, newmalloc( ) calls mmap with the flag MAP_SHARED specified. At step 218, mmap returns memory from the file system buffer cache 110, then processing continues at step 222.

If at step 212 the operating system 102 ascertains that MALLOC_MAP_SHARED is set to 0, processing continues at step 220 where newmalloc( )—functioning essentially as the conventional malloc( )—allocates memory with sbrk( ) or conventional mmap( ) with MAP_PRIVATE set. Processing then continues at step 222.

At step 222, the application continues until the memory allocated at step 218 or 220 is freed (i.e. made the subject of a free( ) call). At step 224, the operating system 102 checks whether MALLOC_MAP_SHARED is set to 1; if so, at step 226 free( ) also deletes the temporary file object or objects 118. Processing, with respect to memory allocation, then ends.

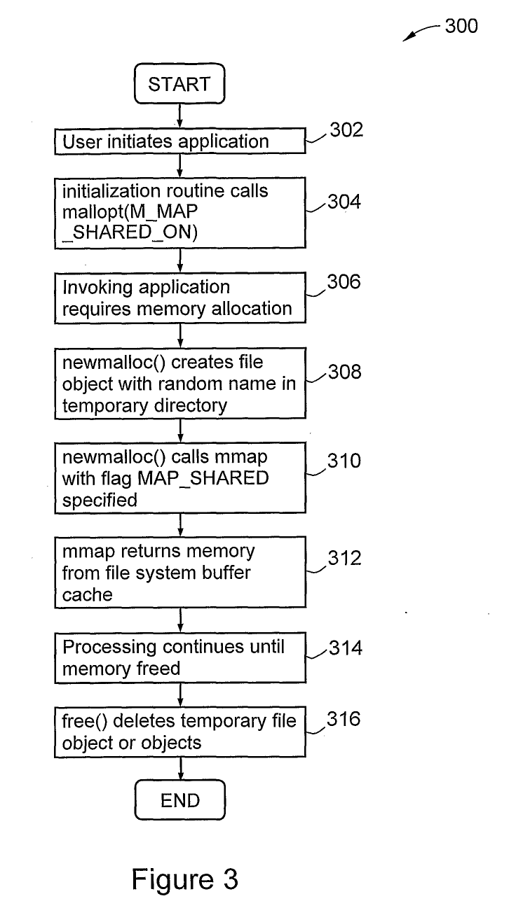

FIG. 3 is a flow diagram of the operation of the system 100 of FIG. 1 with a large application that uses the mallopt( ) call and that requires protection from malloc( ) failures. In this embodiment, the application has been written with an initialization routine that includes a call of mallopt(M_MAP_SHARED_ON).

Thus, at step 302, the application 104 is initiated. At step 304, the initialization routine of application 104 calls mallopt(M_MAP_SHARED_ON), which signals to newmalloc( ) that, when called, it should call mmap with the flag MAP_SHARED specified. At step 306 the invoking application 104 requires memory allocation so invokes newmalloc( ). At step 308, newmalloc( ) creates a new file object 118 with a random name in a temporary directory and, at step 310, newmalloc( ) triggers mmap with (owing to configuration command M_MAP_SHARED_ON) MAP_SHARED specified. At step 312, mmap returns memory from the file system buffer cache 110.

At step 314, the application continues until the memory allocated at step 312 is freed (i.e. made the subject of a free( ) call). At step 316, free( ) deletes the temporary file object or objects 118. Processing, with respect to memory allocation, then ends.

Thus, essentially any large application that requires protection from memory allocation failures need only include a call of mallopt(M_MAP_SHARED_ON) in its initialization routine. This should prevent most if not all memory allocation failure arising from swap size limitations. Also, any large memory allocation prone to failure can be protected with a call to mallopt( ) (M_MAP_SHARED_ONCE) in existing applications.

New applications—as developed—can identify datastructures that should be allocated in a fork( )-safe manner. Such applications can turn off the use of MAP_SHARED (with M_MAP_SHARED_OFF) whenever memory is being allocated for such routines.

Advanatages

Existing implementations of malloc( ) greatly limit the total amount of malloc-able memory available to applications; most malloc( ) failures occur when a system is unable to reserve space on the swap device for the requested amount of memory. The present invention eliminates such restrictions, as newmalloc( ) is permitted to use file system space (which is usually much larger than the swap device). Hence, according to the present invention, applications are able to make large memory allocation requests without any likely failure. Little if any change to existing code is necessary (owing to the use of the environmental variable MALLOC_MAP_SHARED=1 before invoking the application, and even very large applications can be adapted to use this approach with minimal code change.

In addition, calls to realloc( ) can readily be achieved by extending the current filesize and size of the region mapped with mmap. This allows the copying of data to be avoided. Also, newmalloc( ) can use its knowledge of the underlying filesystem block size to create files with optimal sizes, and automatic garbage collection of temporary files is possible.

Limitations

As noted above, the memory returned using this call is not fork( ) safe. The Unix system call “fork( )” duplicates the memory layout of a “parent process” to a newly created “child process”. Such a duplication of memory obtained with a MAP_SHARED flag will result in sharing of the data structures also, if allocated via newmalloc( ). Hence, any changes to these data structures made by the child process will be reflected in the parent process, which can result in undetermined behaviour of the application. However, this problem affects only a limited class of applications—those that depend on malloc'd memory to be fork-safe—and in any event newmalloc( ) can simply be controlled to behave like the conventional malloc( ) for these fork-unsafe applications.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method of allocating memory in a computing environment, comprising:
providing a memory allocation routine adapted to use mmap( ) with a MAP_SHARED or equivalent flag specified so that said memory is allocated from a file system buffer cache.

2. A method as claimed in claim 1, wherein said memory allocation routine comprises a memory reallocation routine.

3. A method of allocating memory in a computing environment, comprising:
allocating said memory by using mmap( ) with a MAP_SHARED or equivalent flag specified so that said memory is allocated from a file system buffer cache.

4. A software product for adjusting parameters for dynamic memory allocation, comprising:
a configuration command usable to control a memory allocation routine invocation to use mmap( ) with MAP SHARED.

5. A product as claimed in claim 4, wherein said configuration command is also usable to control said memory allocation routine to allocate memory backed to swap space.

6. A product as claimed in claim 4, further comprising a another configuration command for said memory allocation routine invocation to give preference to MAP_SHARED on MAP_PRIVATE or brk( ).

7. A product as claimed in claim 4, further comprising a another configuration command for allocating memory in safe mode to allow said memory to have an overflow/underflow check.

8. A product as claimed in claim 1, further comprising a another configuration command for controlling only a next call to said memory allocation routine to use MAP_SHARED.

9. A product as claimed in claim 1, further comprising a another configuration command for switching off use of MAP_SHARED, so that said memory allocation routine behaves like conventional malloc( ).

10. A computing system, comprising:
a memory allocation routine adapted to use mmap( ) with a MAP_SHARED or equivalent flag specified so that said memory is allocated from a file system buffer cache.

11. A system as claimed in claim 10, wherein said memory allocation routine comprises a memory reallocation routine.

12. A computing system, comprising:
a memory allocation routine adapted to invoke mmap( ) to allocate memory from a file system buffer cache.

13. A computing system, comprising:
a product for adjusting parameters for dynamic memory allocation comprising a configuration command usable to control a memory allocation routine invocation to use mmap( ) with MAP_SHARED.

14. A system as claimed in claim 13, wherein said memory allocation routine comprises malloc( ) or realloc( ).

15. A system as claimed in claim 13, further comprising a another configuration command for said memory allocation routine invocation to give preference to MAP_SHARED on MAP_PRIVATE or brk( ).

16. A system as claimed in claim 13, further comprising a another configuration command for allocating memory in safe mode to allow said memory to have an overflow/underflow check.

17. A system as claimed in claim 13, further comprising a another configuration command for controlling only a next call to said memory allocation routine to use MAP_SHARED.

18. A system as claimed in claim 13, further comprising a another configuration command for switching off use of MAP_SHARED, so that said memory allocation routine behaves like conventional malloc( ).

19. A method of allocating memory in a computing environment, comprising:
setting an environmental variable;
initiating a software application;
said software application invoking malloc( );
malloc( ) controlling an operating system to create a file object;
malloc( ) calling mmap, mmap being called with MAP_SHARED or equivalent flag specified owing to said environmental variable being set; and
mmap returning memory from a file system buffer cache.

20. A computer readable medium provided with program data that, when executed on a computing system, implements the method of claim 1.
